(19) United States
(12) Patent Application Publication
(10) Pub. No.: US 2009/0268039 A1
(43) Pub. Date: Oct. 29, 2009

(54) APPARATUS AND METHOD FOR OUTPUTTING MULTIMEDIA AND EDUCATION APPARATUS BY USING CAMERA

(76) Inventor: Man Hui Yi, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/111,349

(22) Filed: Apr. 29, 2008

(51) Int. Cl. H04N 5/225; G06K 9/34

(52) U.S. Cl. 348/207.1; 382/177; 348/373; 348/E05.024; 348/E05.026

(57) ABSTRACT

An apparatus and method for outputting multimedia and an education apparatus by using camera are disclosed, wherein an object is photographed by a camera, feature points are extracted from images of the photographed object and multimedia corresponding to images that accords the most with the feature points are outputted from a database, such that an output speed of the multimedia can be increased.

### BACKGROUND

The following description generally relates to an apparatus and method for outputting multimedia capable of increasing an output speed of the multimedia and an education apparatus by using camera.

Education is defined as the imparting of knowledge, the learning of specific skills and imparting of knowledge, positive judgment and well-developed wisdom. The conventional education largely encompassed the teaching by teachers, learning by way of textbooks and learning (study) assistant papers, educational lectures via Internet and on-the-spot education. It is therefore essential that educational apparatus be developed for enhancing the educational effect, outgrowing the conventional methods.

### SUMMARY

An object of this novel concept is to provide an apparatus and method for outputting multimedia capable of increasing an output speed of the multimedia and an education apparatus by using camera, wherein an object is photographed by a camera, feature points are extracted from images of the photographed object and multimedia corresponding to images that accords the most with the feature points are outputted from a database.

Another object is to provide an apparatus and method for outputting multimedia capable of increasing an output speed of the multimedia and an education apparatus by using camera, wherein size of data of feature points extracted from images of the object and the feature points extracted from a plurality of objects pre-listed in a database are small to thereby enable to improve a retrieving speed and to increase an output speed of the multimedia.

In one general aspect, an apparatus for outputting multimedia comprises: a camera for photographing an object; an image signal processor for processing an image signal of the object photographed by the camera; a feature point pattern extractor for extracting a particular pattern composed of feature points from the image signal processed by the image signal processor; a storage for storing a database in which respective patterns composed of feature points extracted from each of the respective object images and multimedia are mapped, and for storing the multimedia; a database retriever for retrieving a pattern that accords the most with the feature points of the particular pattern extracted from the feature point pattern extractor in the database stored in the storage; and a multimedia output unit for outputting the multimedia mapped to the patterns retrieved by the database retriever.

In another general aspect, a method for outputting multimedia comprises: photographing, by a camera, an object; extracting patterns composed of feature points from images of the photographed object; and outputting multimedia mapped to a pattern that accords the most with the feature points of a particular pattern extracted from the images of the object, from database in which respective patterns composed of the feature points respectively extracted from the images of the photographed objects and multimedia are mapped.

In still another general aspect, an education apparatus by using camera comprises: a support plate on which an object is placed; a support fixed to the support plate and having a predetermined height (H); a camera disposed at the support; and a driving unit for receiving images photographed by the camera to output multimedia.

### BRIEF DESCRIPTION OF THE DRAWINGS

FIG. 1 is a schematic block diagram illustrating an apparatus for outputting multimedia.

FIGS. 2a to 2c illustrate a process in which patterns are formed by extracting feature points from images of an object photographed by a camera.

FIG. 3 illustrates a process in which patterns composed of feature points and multimedia are mapped.

FIG. 4 is a flowchart of a method for outputting multimedia.

FIG. 5 illustrates an exemplary implementation in which multimedia are outputted.

FIGS. 6a and 6b are schematic views illustrating a state of an object that is photographed by a camera.

FIG. 7 illustrates a schematic view of an education apparatus by a camera.

FIG. 8 is a schematic view illustrating a state in which voice is outputted from an education apparatus by a camera.

FIG. 9 is a schematic block diagram illustrating another exemplary implementation of an apparatus for outputting multimedia.

FIG. 10 is a flowchart of another method for outputting multimedia.

### DETAILED DESCRIPTION

Exemplary implementations of the present inventive concept will be described with reference to the accompanying drawings.

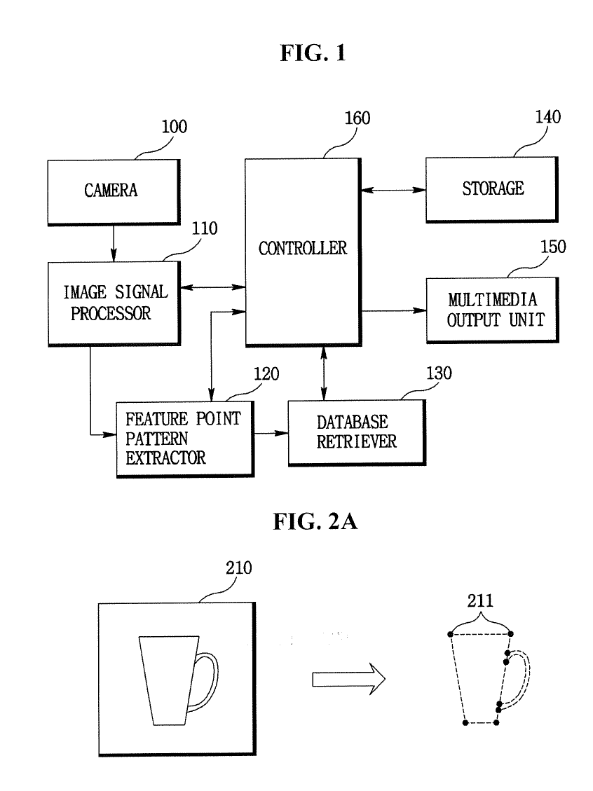

Referring to FIG. 1, the apparatus for outputting multimedia may comprise: a camera 100 for photographing an object; an image signal processor 110 for processing an image signal of the object photographed by the camera 100; a feature point extractor 120 for extracting patterns composed of feature points from the image signal processed by the image signal processor 110; a storage 140 for storing a database in which respective patterns composed of feature points extracted from each of the respective images of a plurality of objects are pre-mapped and for storing the multimedia; a database retriever 130 for retrieving a pattern that accords the most with the feature points of the particular pattern extracted from the feature point pattern extractor 120 in the database stored in the storage 140; and a multimedia output unit 150 for outputting the multimedia mapped to the patterns retrieved by the database retriever 130. The image signal processor 110, the feature point pattern extractor 120, the storage 140, the database retriever 130 and the multimedia output unit 150 may be controlled by a controller 160.

An object in the apparatus for outputting multimedia thus constructed may be photographed by the camera 100 and an image signal of the object photographed by the camera 100 may be processed by the image signal processor 110. The apparatus may receive the image signal processed by the image signal processor 110 and the feature point extractor 120 may extract patterns composed of feature points.

Meanwhile, the storage 140 may be stored with database in which respective patterns composed of feature points respectively extracted from the images of a plurality of objects and multimedia are pre-mapped.

Therefore, the database retriever 130 may retrieve patterns that accord the most with the feature points of a pattern extracted by the feature point extractor 120 in the database stored in the storage 140. If the pattern that accords the most is retrieved by the database retriever 130 in the database retriever 130, the multimedia output unit 150 may output the multimedia mapped to the pattern stored in the storage 140 according to the control of the controller 160. The multimedia output unit 150 is preferably a speaker or a display unit.

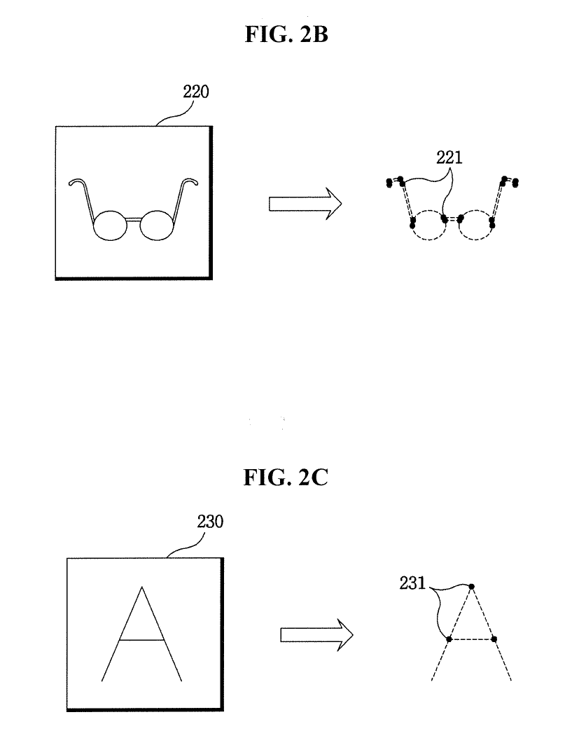

Now, referring to FIGS. 2a, 2b and 2c, if an image photographed by the camera includes a shape, and if a point joined by a line and a line, or a point on a surface joined by a surface and a surface included in the image is defined as a feature point, a pattern composed of the feature points in the image of an object photographed by the camera may be extracted.

In other words, as illustrated in FIG. 2a, if an object is a piece of paper drawn up with a glass cup, the shape photographed by the camera is the glass cup, whereby a pattern composed of the feature points 211 from an image 210 of the glass cup may be extracted. In the same context, if an object is a piece of paper drawn up with a pair of glasses, the shape photographed by the camera is the pair of glasses, whereby a pattern composed of the feature points 221 from an image 220 of the pair of glasses may be extracted, as illustrated in FIG. 2b Again, as depicted in FIG. 2c, if an object is a piece of card written in with a letter of ‘A’, the shape photographed by the camera is the letter ‘A’, whereby a pattern composed of the feature points 231 from an image 230 of the letter ‘A’ may be extracted.

Preferably, an object is one of fairy tale storybooks, toys, language cards, pictures and photographs. In the present implementation, the object is not limited to one of the fairy tale storybooks, toys, language cards, pictures and photographs, but may encompass any objects that can derive images photographed by a camera.

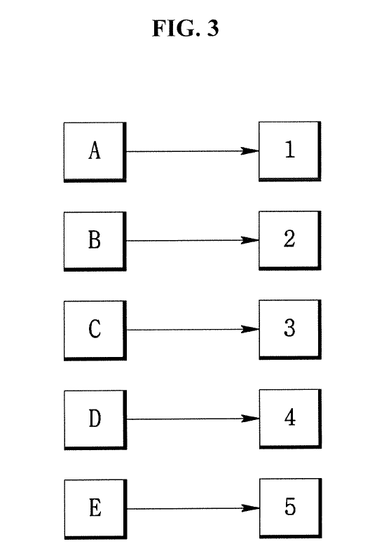

Now, referring to FIG. 3, each pattern (A, B, C, D, E) composed of feature points may be mapped correspondingly opposite to multimedia (1, 2, 3, 4, 5). The respective patterns (A, B, C, D, E) composed of feature points may be mapped by multimedia becoming intrinsic features of images of objects by the mapping method thus described to thereby enable a formation of a database.

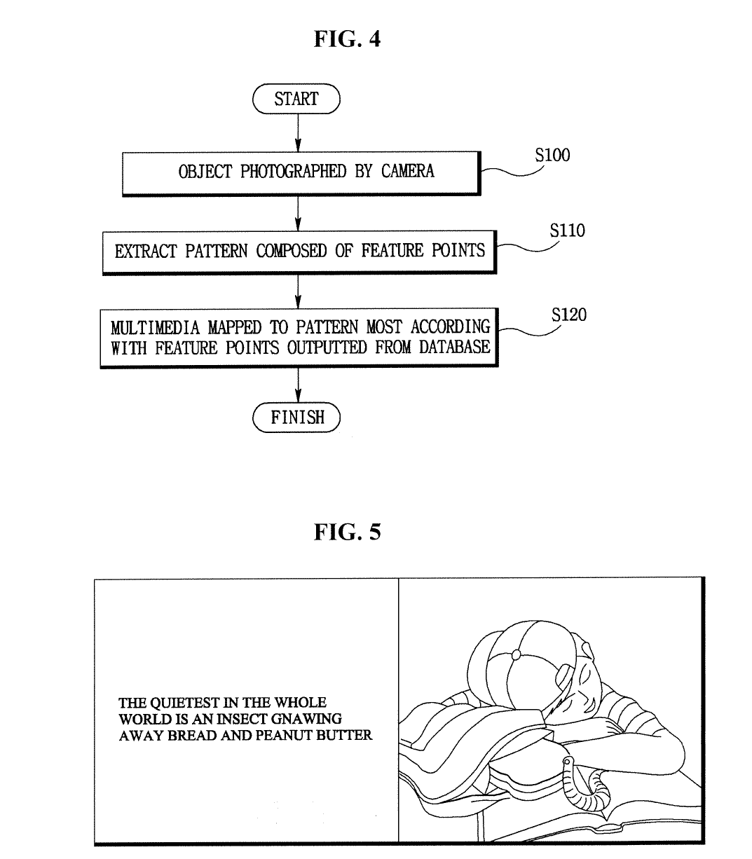

FIG. 4 is a flowchart of a method for outputting multimedia, where an object may be photographed by a camera in the first place (S100). A pattern composed of feature points may be extracted from an image of the photographed object (S110).

Successively, multimedia mapped to a pattern that accords the most with the feature points of a particular pattern extracted from the images of the object may be outputted from a database in which respective patterns composed of the feature points respectively extracted from the images of the photographed objects (S120), where the multimedia is preferably an audio system or a video system.

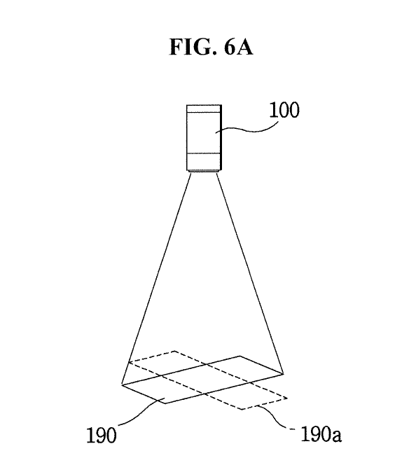

Referring now to FIG. 5, a camera which is an output apparatus may photograph a fairy tale book, if the object is a fairy tale storybook, and a pattern composed of feature points may be extracted from the feature point pattern extractor.

If a pattern is retrieved that accords the most with the feature points of the particular pattern extracted from the feature point pattern extractor in the database stored in the storage, a multimedia output unit may output the multimedia that is mapped to the retrieved pattern. At this time, because the object is a fairly tale storybook as shown in FIG. 5, it is preferable that an audio sound of “the quietest in the whole world is an insect gnawing away bread and peanut butter” be outputted, which is listed in the fairy tale storybook.

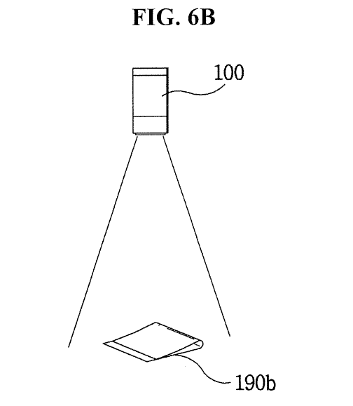

FIGS. 6a and 6b are schematic views illustrating a state of an object that is photographed by a camera. An object is photographed by a camera, feature points are extracted from an image of the photographed object, and multimedia that accords the most with the feature points is outputted from the database, such that an output speed of the multimedia can be enhanced.

In other words, as soon as a user places an object on a photographing range of a camera, a multimedia comes to be outputted. As a result, data size of the feature points extracted from the image of the object is small, and data size of the feature points extracted from the plurality of objects pre-listed in the database is also small, such that the retrieving speed can be enhanced and the output speed of the multimedia can be increased.

Furthermore, because multimedia that accords the most with the feature points is outputted from the database, the output speed of the multimedia can be increased without recourse to complicated comparison and operation functions.

Besides, as shown in FIG. 6a, even if an object is placed in various directions (190, 190a) in the photographing region of the camera 100, the feature points can be extracted to allow the multimedia to be outputted instantly. Even if an object is a folded bank note (190b) placed on a photographing region of the camera 100, the feature points can be extracted to allow the multimedia to be outputted.

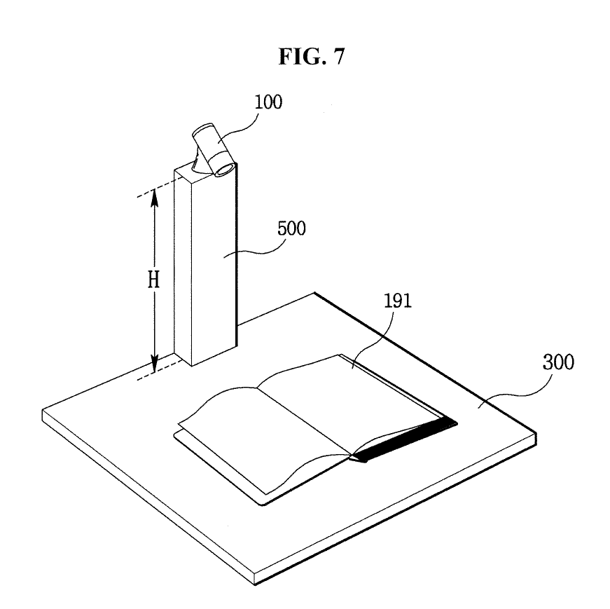

Now, referring to FIG. 7, an education apparatus may comprise: a support 500 having a predetermined height (H); a camera 100 disposed at the support for photographing an object; and a driving unit (not shown) for receiving images photographed by the camera 100 to output multimedia.

As illustrated in FIG. 7, it is preferable that a support plate 300 on which an object to be photographed by the camera 100 is placed for fixing the support 500 be further mounted at the education apparatus. The driving unit is preferably disposed inside the support plate 300 or the support 500. Furthermore, the support 500 is preferably shaped of a toy type support including, for instance but not limited thereto, a robot, a doll, a dinosaur, a spaceship or a car. Still furthermore, the camera 100 is preferably disposed on an upper surface of or inside the support 500. For example, if the support 500 is shaped of a robot, the camera is mounted on a head portion of the robot. An object that is placed on the support plate 300 in FIG. 7 is a book 191. Preferably, the multimedia is one of a reading sound of a book, a music sound, an animal sound, an effect sound, a multi-language leaming audio or video.

Meanwhile, the driving unit may comprise: an image signal processor for processing an image signal of an object photographed by a camera; a feature point pattern extractor for extracting patterns composed of feature points from the image signal processed by the image signal processor; a storage for storing a database in which respective patterns composed of feature points extracted from each of the respective images of a plurality of objects are pre-mapped and for storing the multimedia; a database retriever for retrieving a pattern that accords the most with the feature points of the particular pattern extracted from the feature point pattern extractor from the database stored in the storage; and a multimedia output unit for outputting the multimedia mapped to the patterns retrieved by the database retriever.

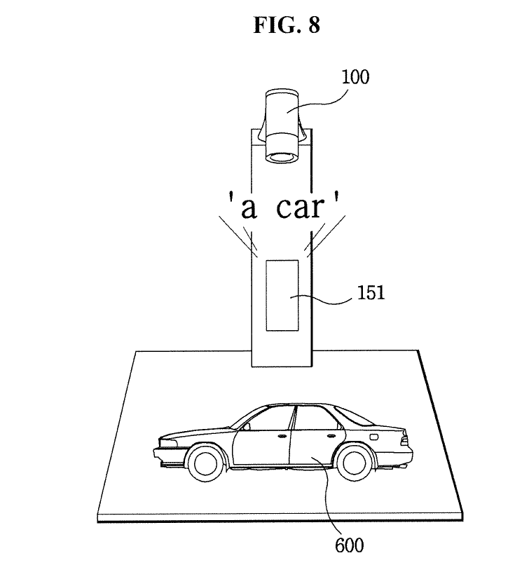

Referring to FIG. 8, if a toy car 600 is put on the support plate 300, a speaker 151 may instantly output a voice sound of ‘a car’ as soon as the car 600 is photographed by the camera 100. Therefore, the present disclosure can provide interest and curiosity to a user to enhance the educational effect.

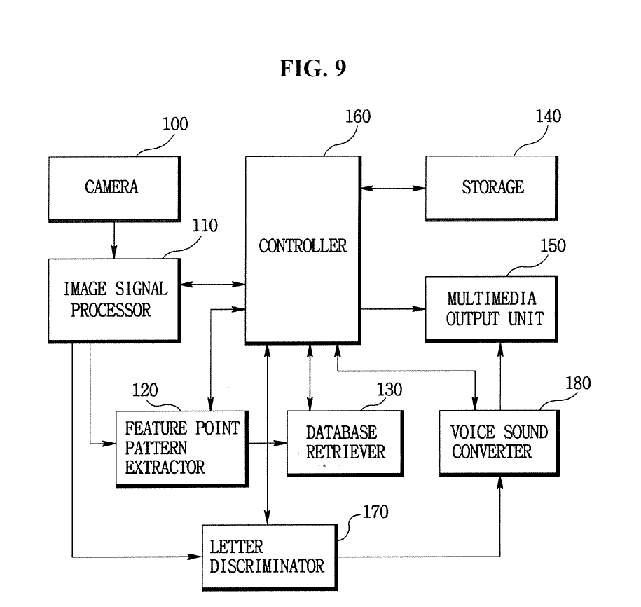

Now, referring to FIG. 9, the apparatus may comprise: a camera 100 for photographing an object; an image signal processor 110 for processing an image signal of the object photographed by the camera 100; a feature point pattern extractor 120 for extracting a particular pattern composed of feature points from the image signal processed by the image signal processor 110; a storage 140 for storing a database in which respective patterns composed of feature points extracted from each of the respective object images and multimedia are mapped, and for storing the multimedia; a database retriever 130 for retrieving a pattern that accords the most with the feature points of the particular pattern extracted from the feature point pattern extractor 120 in the database stored in the storage 140; a letter discriminator 170 for discriminating letters from the image signal processed by the image signal processor 110 to output a signal; a voice sound converter 180 for receiving the signal outputted from the letter discriminator 170 to convert the signal to a voice sound; and a multimedia output unit 150 for outputting the multimedia mapped to the patterns retrieved by the database retriever 130 and the voice sound outputted from the sound converter 180.

Now, the operation of the apparatus for outputting multimedia will be described.

First, an object may be photographed by the camera 100, and an image signal of the object photographed by the camera 100 may be processed by the image signal processor 110, where the letter discriminator 170 may discriminate the letters from the image signal processed by the image signal processor 110 to output a signal.

Successively, if the signal outputted from the letter discriminator 170 may be received by the voice sound converter 180, the signal may be converted to a voice sound and outputted to the multimedia output unit 150, the multimedia output unit 150 may output a voice sound relative to the letter of the object. As noted above, the apparatus for outputting multimedia according to another implementation is further disposed with the letter discriminator 170 and the voice sound converter 180 as compared with the apparatus for outputting multimedia of FIG. 1, such that a user convenience can be further enhanced as the letters of the object can be discriminated and outputted in a voice sound.

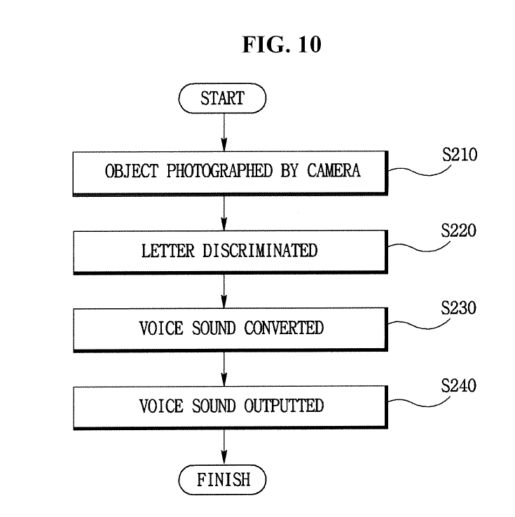

Now, referring to FIG. 10, an object is photographed by a camera (S210). A letter is discriminated from an image of the photographed object (S220). The discriminated letter is converted to a voice sound (S230) and the converted voice sound is outputted (S240), where it is preferred that the ‘S220’ step of discriminating the letters from the image of the photographed object and the ‘S230’ step of converting the discriminated letter to a voice sound be included in the ‘S110’ step of extracting patterns composed of feature points in the image of the photographed object in the method for outputting multimedia of FIG. 4. Furthermore, it is preferred that the ‘S240’ step of outputting the converted voice sound be included in the ‘S120’ step of outputting multimedia in the method for outputting multimedia of FIG. 4.

As apparent from the foregoing, the apparatus and method for outputting multimedia and an education apparatus by using a camera according to this novel concept has an advantage in that an output speed of the multimedia can be increased because an object is photographed by a camera, feature points are extracted from images of the photographed object and multimedia corresponding to images that accords the most with the feature points are outputted from a database.

Another advantage is that size of feature points extracted from images of the object and data of the feature points extracted from a plurality of objects pre-listed in a database are small to thereby enable to improve a retrieving speed and to increase an output speed of the multimedia.

Still another advantage is that multimedia that accords the most with the feature points is outputted from the database, the output speed of the multimedia can be increased without recourse to complicated comparison and operation functions.

Still another advantage is that interest and curiosity can be derived from a user to enhance the educational effect because the multimedia can be outputted the moment an object is put on a photographing region of a camera by the user.

Still further advantage is that a user convenience can be enhanced as the letters of the object can be discriminated and outputted in a voice sound by the letter discriminator and the voice sound converter disposed at the apparatus.

While the present disclosure has been particularly shown and described with reference to exemplary implementations thereof, it will be understood by those of ordinary skill in the art that various changes in form and details may be made therein without departing from the spirit and scope of the present general concept as defined by the following claims.

What is claimed is:

1. An apparatus for outputting multimedia comprising: a camera for photographing an object; an image signal processor for processing an image signal of the object photographed by the camera; a feature point pattern extractor for extracting a particular pattern composed of feature points from the image signal processed by the image signal processor; a storage for storing a database in which respective patterns composed of feature points extracted from each of the respective object images and multimedia are mapped, and for storing the multimedia; a database retriever for retrieving a pattern that accords the most with the feature points of the particular pattern extracted from the feature point pattern extractor in the database stored in the storage; and a multimedia output unit for outputting the multimedia mapped to the patterns retrieved by the database retriever.

2. The apparatus as claimed in claim 1, further comprising: a letter discriminator for discriminating letters from the image signal processed by the image signal processor to output a signal; and a voice sound converter for receiving the signal outputted from the letter discriminator to convert the signal to a voice sound, wherein the multimedia output unit further outputs the voice sound outputted by the voice sound converter.

3. The apparatus as claimed in claim 1, wherein the multimedia output unit is a speaker or a display unit.

4. The apparatus as claimed in claim 1, wherein the object is one of the shape of a fairy tale storybook, a toy, a language card, a picture or a photograph.

5. A method for outputting multimedia comprising: photographing, by a camera, an object; extracting patterns composed of feature points from images of the photographed object; and outputting multimedia mapped to a pattern that accords the most with the feature points of a particular pattern extracted from the images of the object, from database in which respective patterns composed of the feature points respectively extracted from the images of the photographed objects and multimedia are mapped.

6. The method as claimed in claim 5, wherein the step of extracting patterns composed of feature points from the image of the photographed object further includes discriminating letters from the image of the photographed object and converting the discriminated letters to voice sound, wherein the step of outputting multimedia mapped to a pattern that accords the most with the feature points of a particular pattern extracted from the images of the object, from database in which respective patterns composed of the feature points respectively extracted from the images of the photographed objects and multimedia are mapped further includes outputting the converted voice sound.

7. The method as claimed in claim 5, wherein the image that has photographed the object includes a shape, and the feature point is defined by a point joined by a line and a line, or a point on a surface joined by a surface and a surface included in the image.

8. The method as claimed in claim 5, wherein the multimedia is an audio system or a video system.

9. An education apparatus comprising: a support having a predetermined height (H); a camera disposed at the support for photographing an object; and a driving unit for receiving images photographed by the camera to output multimedia.

10. The apparatus as claimed in claim 9, further comprising a support plate on which an object to be photographed by the camera is placed for fixing the support.

11. The apparatus as claimed in claim 9, wherein the driving unit comprises: an image signal processor for processing an image signal of an object photographed by a camera; a feature point pattern extractor for extracting patterns composed of feature points from the image signal processed by the image signal processor; a storage for storing a database in which respective patterns composed of feature points extracted from each of the respective images of a plurality of objects are pre-mapped and for storing the multimedia; a database retriever for retrieving a pattern that accords the most with the feature points of the particular pattern extracted from the feature point pattern extractor from the database stored in the storage; and a multimedia output unit for outputting the multimedia mapped to the patterns retrieved by the database retriever.

12. The apparatus as claimed in claim 11, wherein the driving unit further comprises: a letter discriminator for discriminating letters from the image signal processed by the image signal processor to output a signal; and a voice sound converter for receiving the signal outputted from the letter discriminator to convert the signal to a voice sound, wherein the multimedia output unit further outputs the voice sound outputted by the voice sound converter.

13. The apparatus as claimed in claim 10, wherein the driving unit is mounted inside the support plate or the support.

14. The apparatus as claimed in claim 10, wherein the support is a toy type support.

15. The apparatus as claimed in claim 9, wherein the camera is placed on an upper surface of or inside the support.

16. The apparatus as claimed in claim 9, wherein the multimedia is one of a reading sound of a book, a music sound, an animal sound, an effect sound, a multi-language learning audio or video.
